(19) United States
(12) Patent Application Publication
(10) Pub. No.: US 2011/0318503 A1
(43) Pub. Date: Dec. 29, 2011

(54) PLASMA ENHANCED MATERIALS DEPOSITION SYSTEM

(76) Inventors: Christian ADAMS, Yalaha, FL (US); Matthew Kelley, Orlando, FL (US)

(21) Appl. No.: 13/158,220

(22) Filed: Jun. 10, 2011

Related U.S. Application Data
(60) Provisional application No. 61/359,668, filed on Jun. 29, 2010.

(51) Int. Cl. B05C 11/10; H05H 1/24

(52) U.S. Cl. 427/535; 118/719; 118/697; 118/696

(57) ABSTRACT

A system and method for combined material deposition and plasma and/or controlled atmosphere treatment processing of substrates. In one variation, plasma and/or controlled atmosphere treatment and deposition are performed using a single processing system with multiple processing areas. In another variation, plasma and/or controlled atmosphere treatment and deposition are performed using a single processing system with a single processing area. Variations of deposition include printing or direct-write techniques. Processing areas may be atmospherically controlled or selectively sealable.

### FIELD OF THE INVENTION

The present invention claims benefit of priority to Provisional Application 61/359,668, filed in the U.S. Patent and Trademark Office on Jun. 29, 2010, the entire contents of which are hereby incorporated by reference.

The present invention relates generally to plasma- or controlled atmosphere-assisted materials deposition and, more specifically, to a single solution for multi-material, multi-layer plasma/controlled atmosphere-assisted deposition. Aspects of the present invention relate to solving adhesion and material-stress concerns involved in depositing layers of disparate materials on each-other.

### BACKGROUND OF THE INVENTION

Although plasma-treatment systems are known and used in materials processing, they are stand-alone devices used to treat wholly or partially completed components after or in preparation for a particular processing step.

### Material Deposition Systems

Current materials deposition systems include a wide range of configurations that may vary in the mechanism by which material is deposited and handled, the resolution and accuracy of the deposition system, the materials and material classes which can be used by the system, and the compatibility with in-line or conveyor-based production lines.

Current systems rely on the material properties of both what is being deposited and the makeup of the surface which is receiving the deposit to ensure a successful bond. Disregarding this relationship can lead to poor adhesion or otherwise unfavorable results. Different methods for promoting adhesion include chemical pretreatments, roughening of the surface using abrasives (either via liquid slurry or airborne abrasion techniques), and other techniques including atmospheric modification (e.g. inert atmosphere, or some specific gas such as CO₂ or oxygen) and plasma activation. None of these adhesion promotion techniques are utilized in current materials deposition systems.

### Plasma Treatment Systems

Current state of the art plasma treatment systems leverage RF energy fields combined with selected process gases. Properly energized, these process gases form plasma which in turn alters or improves the adhesion properties of surfaces prior to coating, painting, etc. In the case of a polymer material, or example, an oxygen plasma will lead to the formation of carbonyl groups (C═O) on the surface. Such polar groups will lead to hydrophilicity, which in turn results in increased adhesion to other polar materials. By selecting different process gases, different materials can be prepared for adhesion promotion or reduction.

A component that benefits from plasma treatment before a material deposition process therefore necessitates the use of two physically separate systems. Transporting components between the two systems involves additional time and cost, as well as the potential for damage and defects introduced during the transport process. This is especially true with certain plasma processes where the treated surfaces may revert upon exposure to air or with lapse of time. See, for example, Plasma Modification of PTFE surfaces, Part II: Plasma-treated surfaces following storage in air or PBS by D. J. Wilson et. al, Surface and Interface Analysis, Vol. 31 Issue 5, Pages 385-396, 2001.

Measures to avoid damage or reversion may include the use of clean-room procedures or protocols that add significant expense to an overall production process. Also, the production facility becomes more difficult to arrange and operate due to the access and maintenance concerns associated with clean-rooms and moving parts into and out of one.

Furthermore, Plasma-modified surfaces may only be active for short periods, generally less than 24 hours when exposed to air. Treated parts should undergo subsequent processing shortly after treatment; otherwise the surface may revert to its untreated, previous state. Even in a clean room, leaving treated parts exposed to air or otherwise susceptible to reversion will result in decreased production yields and higher costs. Furthermore, handling—even in a clean room—can introduce damage or contaminants that reduce the effectiveness of the plasma treatment. Therefore, plasma treatment is most effectual when the environment is controlled and when there is minimal delay between plasma activation and material deposition.

Some materials deposition systems, such as sputtering, spraying, PVD (physical vapor deposition) and CVD (chemical vapor deposition) operate in controlled atmospheres and commonly use plasma to enhance the deposition of films onto the target substrates and surfaces. Printing and direct write systems, however, operate at ambient conditions, so different strategies may be required for integrating an atmospherically-controlled plasma treatment area with a particular material deposition system. Additionally, close proximity of the plasma chamber to the deposition area may reduce potential for contamination of activated surface, and also improve the effectiveness of a time-sensitive plasma surface activation.

### SUMMARY OF THE INVENTION

Including a plasma adhesion-promotion technique in a materials deposition system would be a robust solution because the plasma process can be confined to an area directly connected or otherwise integrated with the work area of the deposition system. Although potentially increasing system complexity and cost, such a solution enables the realization of significant operating efficiencies by reducing both the time lag and handling frequency between plasma treatment and material deposition for a component.

It would therefore be an advantage over the current state of the art to provide a materials deposition system that has built-in plasma treatment capability. Such a system would enable the execution of a comprehensive treatment and deposition process through the use of a single machine, thereby reducing manufacturing time and cost. Furthermore, by controlling the environment of the deposition, a vacuum can be used to de-gas the deposited material to eliminate bubbles that could possibly interfere with subsequent processing. Controlling the environment within the deposition system could have other benefits, such as reduction of cure times or cure stress. Furthermore, most of the modifications required for co-locating a plasma treatment capability would lend themselves to the maintenance of any controlled atmosphere (pressure, gas makeup, etc.) as previously described.

Aspects of the present invention are directed at solving the above-noted problems of materials deposition on plasma-activated surfaces, or material deposition in controlled atmosphere environments. Certain aspects relate to the targeted deposition of materials onto surfaces of interest including, but not limited to, circuit boards and other electronic components.

Embodiments of the present invention pertain to combined processing systems that perform plasma treatment and material deposition with a single device or treatment system. Embodiments of a single device or comprehensive system include plasma processing and material deposition capabilities and a common processing chamber or atmospherically-controlled conveyance system that allows for components to quickly undergo plasma treatment, alternate atmospheric treatment including non-standard gases and operating pressures; along with any material deposition processing in accordance with the given production sequence. Variations of non-standard gas and pressure environments may include settings specifically meant to prevent exposing plasma-treated components to oxygen and oxidizing agents.

Further variations may have data storage and data processing capabilities to allow user/operator control of a production process or sequence or to accept operating profiles or programs associated with a specific production process or sequence.

Further variations may include selective masking features that allow parts to be masked before plasma activation, controlled-atmosphere treatment, and/or before material deposition so that only a particular area of component is subjected to a plasma or deposition processing sequence. These masking features may be deposited using the deposition system itself, or robotically placed and attached as pre-defined template mask onto the surface being treated.

Yet further variations of the present invention pertain to combined plasma treatment controlled-atmosphere treatment, and material deposition processing methods for activating/treating a substrate and applying a coating thereon before the plasma activated substrate begins to revert or degrade.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF DRAWINGS

The present invention will become more fully understood from the detailed description given herein below and the accompanying drawings which are given by way of illustration only, and thus are not limitative of the present invention, and wherein

FIG. 1 depicts a high-level block diagram of an embodiment of a combined plasma, controlled atmosphere, and deposition system as described herein;

FIG. 2 depicts a high-level block diagram of an embodiment of a combined plasma, controlled atmosphere, and deposition system as described herein;

FIG. 3a depicts a more detailed block diagram of an embodiment of a combined plasma, controlled atmosphere, and deposition system as described herein;

FIG. 3b depicts a more detailed block diagram of a component within a combined plasma, controlled atmosphere, and deposition system as described herein;

FIG. 4a depicts a variation of a single-chamber deposition and plasma and/or controlled atmosphere treatment assembly; and

FIG. 4b depicts a variation of a multi-chamber deposition and plasma and/or controlled atmosphere treatment assembly;

FIG. 5a depicts a flowchart of an embodiment of a plasma and/or controlled atmosphere treatment and deposition process using an embodiment of a combined system as described herein;

FIG. 5b depicts a flowchart of an embodiment of a plasma and/or controlled atmosphere treatment and deposition process using an embodiment of a combined system as described herein; and

FIG. 6 depicts a flowchart of an embodiment of a plasma and/or controlled atmosphere treatment and deposition process using an embodiment of a masking process as described herein.

The drawings will be described in detail in the course of the detailed description of the invention.

### DETAILED DESCRIPTION OF THE INVENTION

The following detailed description of the invention refers to the accompanying drawings. The same reference numbers in different drawings identify the same or similar elements. Also, the following detailed description does not limit the invention. Instead, the scope of the invention is defined by the appended claims and equivalents thereof.

Although materials deposition, controlled atmosphere, and plasma treatment are known and widely used fabrication processes for making and altering various mechanical and electronic components, the state of the art has not yet realized the full potential of combining these operations.

Some variations of material deposition systems, such as vapor-deposition, direct-write spraying, or printing systems that deposit preset configurations and amounts of different materials of varying viscosity (such as metallic or dielectric coatings, polymeric coatings, elastomers, metal-bearing inks, underfills, or epoxies) may sometimes encounter difficulty when a deposited material and its associated substrate interact in unexpected or undesirable ways. Certain materials may, for instance, adhere too strongly or too weakly to each-other, or may diffuse into each-other or co-mingle in ways that complicate or otherwise prevent effective use or further processing.

Plasma treatment is a solution to some of the above-mentioned material interaction difficulties, but plasma treatment has its own set of difficulties that have previously limited its effectiveness.

Plasma treatment may improve or alter the properties of a material's surface (such as, for instance, increased or decreased adhesion capability), but plasma treatment benefits may revert or otherwise degrade when a material is exposed to air or simply as a result of the passage of time.

This is especially true in processing strategies that deal with changes to adhesion properties as atmospheric contaminants (dust, particles) as well as ambient oxygen and/or carbon dioxide may adhere to or react with the plasma treated surface and reduce or destroy the plasma-treatment benefits before a treated component can be returned for subsequent material deposition processing.

Similarly, controlled atmosphere treatments can provide benefits that can be analogous to plasma treatments. Changes in surface adhesion, surface cleaning, and similar results can be obtained by exposing parts to controlled atmosphere/pressure/temperature combinations either alone or in conjunction with some form of activated plasma treatment. Such controlled atmosphere treatment techniques may be performed in sealed or sealable processing chambers under conditions similar to those required for plasma treatment.

Embodiments of the present invention seek to address difficulties in material adhesion, deposited material cure, or overall process modification, by providing a combined material deposition and plasma and/or controlled atmosphere treatment device that can perform plasma modification or controlled atmosphere treatment of a surface and immediately perform a subsequent material deposition operation with minimal delay and, in some embodiments, zero to limited exposure to the outside atmosphere before the deposition process completes.

Some embodiments of the present invention are related to a plasma activation and/or controlled atmosphere treatment system that operates on the deposited material and a deposition substrate so that materials may be applied without concern for how a material might interact with a substrate. Embodiments of the plasma activation system may modify one or more of the outermost atomic and/or molecular layers of material in the substrate and/or the deposited material based on the properties of a plasma field. Such altered materials may interact with other materials in ways that are not affected by material incompatibility. The controlled atmosphere treatment system may allow for novel chemical reactions to occur at the surface of material in the substrate and/or the deposited material based on the properties of the gas used with respect to the material in question. Migration of gaseous species into a substrate or deposited material may result in additional desirable chemical reactions. Furthermore, optionally reduced pressure in an inert atmosphere will help to eliminate any air bubbles that may form as part of the deposition process.

Embodiments of the present invention may accomplish such plasma activation by moving a component through a sealed volume with a controlled plasma atmosphere and/or controlled atmosphere treatment system before, after, or between deposition steps. Plasma gases may be used to make surfaces hydrophilic or hydrophobic, to clean a surface by plasma etching and/or ashing, to increase or decrease adhesion of subsequent materials, and to accomplish other material property alterations. Controlled atmosphere treatment system process may allow for novel chemical reactions to occur at the surface of material in the substrate and/or the deposited material based on the properties of the gas used with respect to the material in question.

Variations of a plasma activation and/or controlled atmosphere treatment system according to the present invention may be included as part of a material deposition system such that a component may be modified accordingly either before, between, or after deposition steps without interrupting an overall deposition workflow.

In an embodiment having a plasma activation and/or controlled atmosphere treatment system included as part of a material deposition system or apparatus, the included treatment portion of the overall system as described in the embodiment may be atmospherically separated from the materials deposition system such that an automated part conveyer moves parts between the deposition and plasma activation and/or controlled atmosphere treatment system portions via an air-lock or loadlock portion or portions for loading and unloading. Embodiments of such an air lock may include a chamber which may be atmospherically connected to the main chamber housing the material deposition portion, the atmosphere of the plasma activation portion, or to a vent to create a vacuum or other specific controlled atmosphere treatment system therein. Yet further embodiments may include production systems which may have other automated activities such as connector attachment, electrical test, pick and place, solder attach, etc. Embodiments may include component transport solutions such as an in-line conveyer-based system. Embodiments may use tray or cassette component handling and arrangement solutions. In yet further embodiments, multiple systems can be integrated or interconnected into an overall implementation that offers a wide range of functionality.

Alternate embodiments may include a processing chamber having both materials deposition and plasma treatment and/or controlled atmosphere treatment system components disposed therein. In some embodiments of such a combined processing approach, the plasma treatment and/or controlled atmosphere treatment system and/or materials deposition components may be retractable or otherwise removable from the chamber such that materials deposition processing components are not exposed to a plasma atmosphere. Yet further embodiments may include robotic part conveyance or alignment solutions that may move or re-arrange components within a chamber. In one embodiment, a direct-write solution may be accomplished in a plasma treatment chamber with a stationary ‘pen’ or deposition head and an actuated component carrier or vice versa.

Yet further embodiments may include a selectively sealable chamber that may be hermetically sealed for plasma processing operations and then optionally vented and un-sealed for material deposition processes. Embodiments of such a selectively sealable chamber may include seal and pressure monitoring capability to ensure that the chamber is properly sealed. Yet further embodiments may include electrical grounding and component shielding for protection of areas on a component or board not requiring direct surface activation via plasma. Embodiments of such shielding or protection may include a metal or polymer shield. Embodiments of a shield may be conformal or shape-specific to a given component and/or plasma run. In such embodiments, a conformal shield may be continuous over a region or may have internal areas that allow contact with the plasma, thereby allowing for more flexibility with respect to activation in specific regions of a processed component.

Yet further embodiments of a combined material deposition and plasma activation and/or controlled atmosphere treatment system may have an isolated segregated loading and/or part output area such that components can be loaded for processing or removed post-processing while the system is in continuous operation. Embodiments of such segregated loading and/or un-loading areas may include embodiments of air-lock portions that allow ongoing conveyance of parts between a plasma atmosphere, controlled atmosphere, and a regular atmosphere. Alternate embodiments may employ a selectively sealable chamber that is configured for component intake/output when un-sealed.

In one specific embodiment a direct-write deposition solution, consisting of a sample stage or platform, a gantry or computer numerically controlled (CNC) ink and/or material deposition system, material feed ports and/or reservoirs, and a unified software interface is enhanced with plasma activation capability.

Variations of processes involving vacuums (sputtering, molecular beam epitaxy (MBE), etc.) may have smaller loading and unloading chambers separated from a larger main processing chamber by loadlock valves. Such configurations may allow for a processing chamber to be maintained at a different pressure and/or atmospheric composition, thereby reducing time associated with pressurization and introduction of gases.

Plasma damage can be mitigated by carefully selecting the appropriate RF energy levels and treatment durations. Mild short-duration plasma treatments can be very specific in terms of the depth of treatment and how surfaces are modified (i.e. to what extent activation occurs).

For variations using conformal coatings (such as acrylic, parylene, silicone, or urethane) as part of a material deposition process, prior plasma treatment for cleaning may achieve better adhesion to the base substrate, whereas subsequent plasma treatment for a follow-on deposition sequence may achieve better levels of uniformity and effectiveness. This is because in variations using uniform, conformal coatings, the surface exposed to the plasma is chemically uniform which makes plasma selection and process tuning more simplistic due to the single chemical identity of the surface. Similarly, surface applications (polymer or metal preform, see above) can be added that act as masks, thus resulting in region-specific plasma activation.

Some variations of a combined material deposition and plasma treatment and/or controlled atmosphere treatment device according to the present invention may also offer the advantages of a multi-purpose device without an increased device footprint. Reduced space requirements may enable production facilities to use a variation of a device according to the present invention to accomplish both plasma treatment and/or controlled atmosphere treatment and material deposition functions, thereby reducing the amount of equipment required and allowing for improved use of space in the production facility.

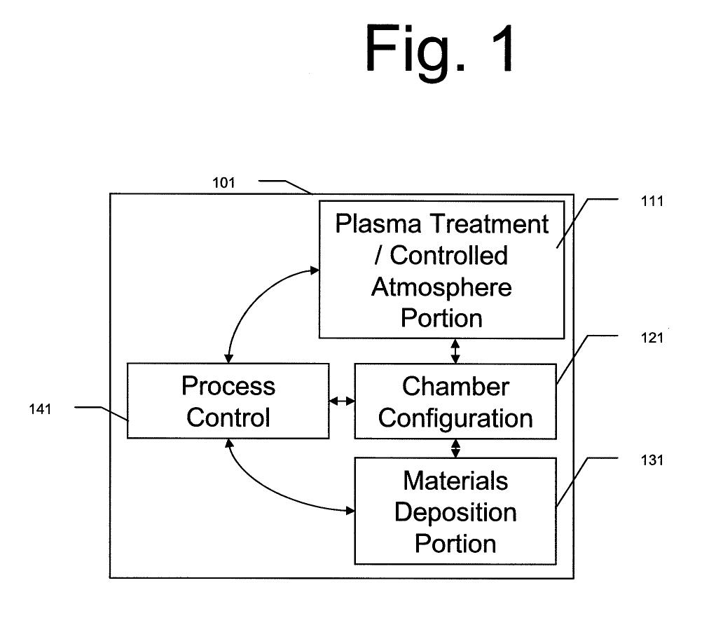

FIG. 1 shows a block diagram of an embodiment of a combined plasma treatment and materials deposition system 101. In a variation of such a system, a plasma treatment and/or controlled atmosphere treatment portion 111 and a materials deposition portion 131 may be governed and synchronized through a process control 141 portion or system that determines when and how to plasma treat and/or controlled atmosphere treat or deposit material onto a substrate. The variation shown is a multi-use chamber variation where a chamber configuration portion 121 may re-configure the arrangement and layout of tools and components within a processing chamber and/or alter the atmospheric composition and temperature within a processing chamber as the system changes from plasma treatment mode to material deposition mode and vice versa. In some variations, either or both the process control portion 141 and chamber configuration portion 221 may also govern and control the movement of the substrate and the activation and control of necessary related components such as conveyors, actuators, air locks, gas pumps, masking/un-masking, and vision recognition and/or component alignment for a particular processing, preparation, or configuration step.

The plasma treatment and/or controlled atmosphere treatment portion 111 may include a controlled atmosphere treatment portion only, or may include a plasma treatment portion operating in conjunction with a controlled atmosphere. A controlled atmosphere process may be performed with or without plasma treatment. Examples of controlled atmosphere treatment processes include exposure to ozone, nitrous oxide, carbon monoxide, halogens, or unstable gases such as halogenated noble gas compounds.

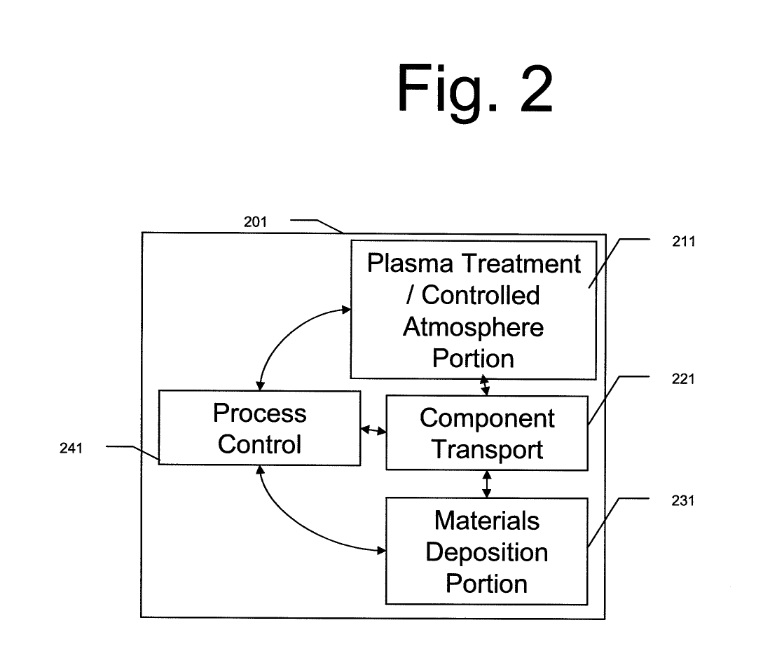

FIG. 2 shows a block diagram of an embodiment of a combined plasma treatment and/or controlled atmosphere treatment and materials deposition system 201. In a variation of such a system, a plasma treatment and/or controlled atmosphere treatment portion 211 and a materials deposition portion 231 may be governed and synchronized through a process control 241 portion or system that determines when and how to plasma treat or deposit material onto a substrate. The variation shown is a multi-chamber variation where a component transport portion 221 may move components between a plasma treatment 211 and a materials deposition 231 portion according to user/operator parameters and/or a production plan. In some variations, either or both the process control portion 241 and the component transport portion 221 may also govern and control the movement of the substrate and the activation and control of necessary related components such as conveyors, actuators, air locks, gas pumps, masking/unmasking, and component alignment for a particular processing, preparation, or transport step.

As with the embodiment discussed in FIG. 1, The plasma treatment and/or controlled atmosphere treatment portion 211 may include a controlled atmosphere treatment portion only, or may include a plasma treatment portion operating in conjunction with a controlled atmosphere. A controlled atmosphere process may be performed with or without plasma treatment. Examples of controlled atmosphere treatment processes include exposure to ozone, nitrous oxide, carbon monoxide, halogens, or unstable gases such as halogenated noble gas compounds. In the present embodiment, air-locks and/or load locks may be implemented both at component loading/un-loading areas as well as similar atmosphere control/air-lock mechanisms to allow for component transport 221 between the plasma/atmosphere portion 211 and the materials deposition portion 231 without exposing the components to air or other potential sources of oxidation/contamination.

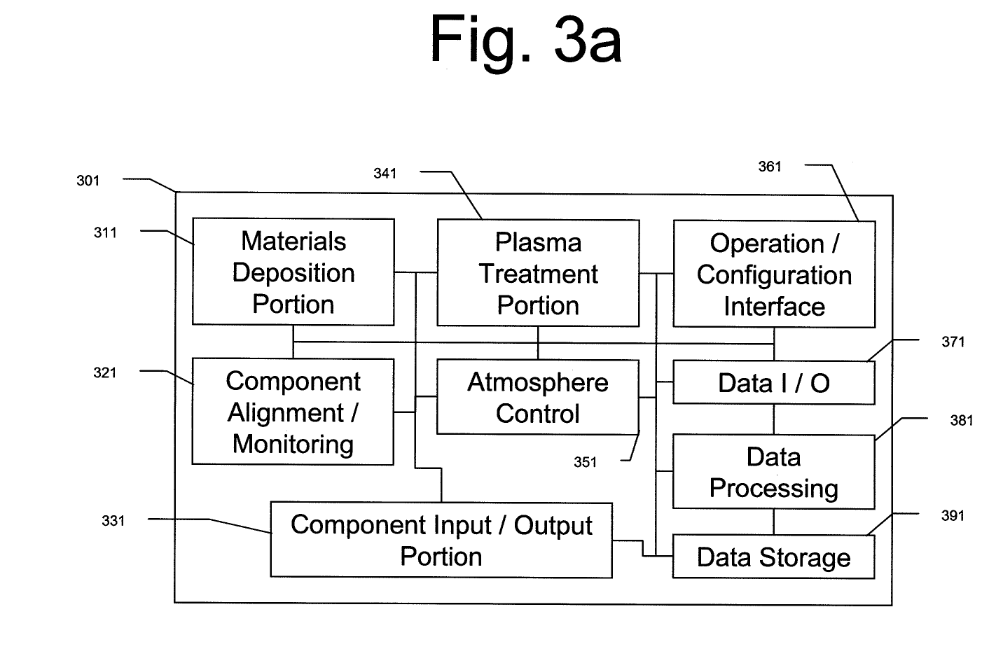

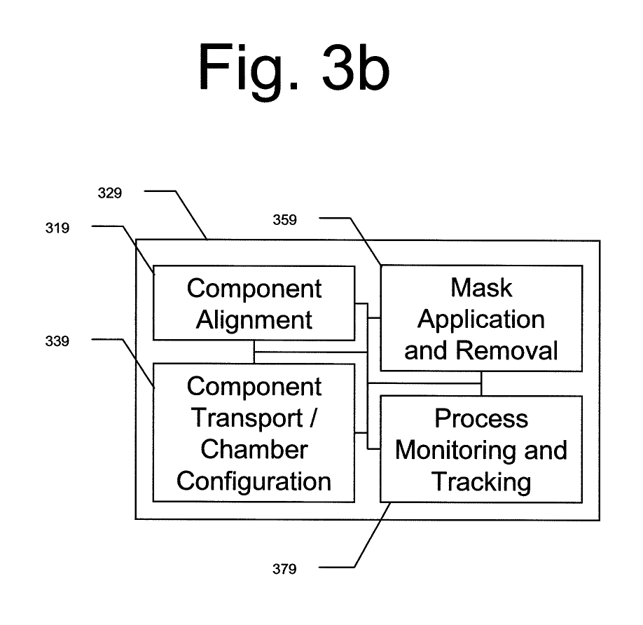

FIG. 3a shows a block diagram of an embodiment of a combined plasma treatment and/or controlled atmosphere treatment and materials deposition system 301. In the variation shown, a materials deposition portion 311, plasma treatment and/or controlled atmosphere treatment portion 341, and operating interface 361 are interconnected with additional components to enable configurable and programmable operation. Component monitoring and alignment 321, component input and output (loading and un-loading) 331, and atmosphere control 351 aspects may be coupled with data input 371, processing 381, and storage 391 capabilities to effect such configurable operation in some variations.

Variations of a materials deposition portion 311 may include physical vapor deposition, chemical vapor deposition, sputtering, screen printing, inkjet-based printing, flame or thermal spray, and/or direct-write material deposition systems. A particular deposition system may be selected based on the range of components/substrates, deposited materials, amount of deposition, and level of precision required. Some variations may use a direct-write system for printing a wide range of materials and coatings on component-bearing circuit boards or other substrates/components having variable or complex topographies. Further variations may use physical vapor deposition with or without a masking process to selectively coat particular portions of a substrate quickly and evenly. Yet further variations may use screen printing to create conductive patterns with metal-bearing ink. Further variations still may use other known material deposition techniques and variations, and/or may combine multiple deposition techniques or approaches.

Variations of a plasma treatment and/or controlled atmosphere treatment portion 341 may employ treatment techniques that include one or more of corona treatment, atmospheric-pressure plasma, flame plasma, chemical plasma, and glow plasma, or simply non-standard gases at user-selected pressures. A particular treatment system may be selected based on the range of components/substrates to be processed, the particular dimensional considerations involved, the particular form(s) of processing required (increased vs. decreased adhesion, material-specific adhesion concerns, chemical diffusion, etc.), the associated deposition process selected, and the material interactions in question. Variations may use plasma certain treatment method with or without a masking process to activate or treat specific portions of a component or substrate. Yet further variations may use a variation of atmospheric plasma with an actuated, controllable nozzle that can target specific areas for treatment. Further variations still may use a combination of flame or chemical plasma with a vapor deposition process in order to effect plasma treatment and material deposition within a single sealed chamber.

Variations of a component alignment and monitoring portion 321 may include a conveyor system with cassettes or trays for loading components or substrates. Further variations may include robotic arms or servo-controlled actuators to move, rotate, and/or maintain the position of a component or component-bearing cassette or tray. Variations may also include position monitoring solutions such as lasers, cameras, other vision systems, and electronic or mechanical sensors to measure and determine the position, location, and attitude of a component or component-bearing cassette or tray and inform relevant conveyors or actuators of any necessary changes in component alignment, location, or position. Yet further variations may include cassette loading/unloading portions, mask application or removal sub-systems, defect recognition/identification, and component testing/validation sub-systems.

In some variations, a component alignment and monitoring portion 321 may also include a mask application/control sub-unit or feature. Such an embodiment is depicted in FIG. 3b. In the variation shown, a component alignment and monitoring portion 329 has component alignment 319, component transport/chamber configuration 339, process monitoring and tracking 379, and mask application and control 359 sub-units.

A variation of a component alignment portion 319 may include sensors and associated control systems along with measurement tolerances or other trigger mechanisms that inform the component alignment portion 319 when a component is or is not in a desired or expected location. Variations of sensors may include cameras, lasers, scales, piezo-electric devices, and strain gauges. Further variations may include actuated devices with built-in detection and monitoring capabilities such as positioning cameras or relative location measurement based on movement.

Variations of a component transport/chamber configuration portion 339 may include either sensors and devices for transporting components and controlling air-locks or other atmosphere-separation devices in variations having separate plasma treatment and/or controlled atmosphere treatment and material deposition areas. Variations having a shared processing area where plasma treatment and/or controlled atmosphere treatment and material deposition may both be performed may have a chamber configuration portion 339 that controls the positioning of tools and equipment within the chamber as well as the configuration of the chamber itself with respect to suitability for a particular set of temperature and internal atmosphere conditions.

Variations of a process monitoring and tracking portion 379 may include optical, chemical, pressure, and temperature sensors to determine the particular processing phase the system is performing. Variations of process monitoring may provide or exchange data with data processing 381 and atmosphere control 351 portions as well as with an operation interface 361. In one variation, a processor monitoring portion may direct and control the transport or configuration portion 339 to vary between plasma treatment and/or controlled atmosphere treatment and direct-write material deposition.

A variation of a mask application and control sub-unit 359 may include aspects that control and perform selectively masking portions of a component prior to plasma treatment and/or controlled atmosphere treatment or material deposition. In one variation, an impermeable mask may be applied to portions of a component prior to a chemical or atmospheric-pressure plasma treatment, or other type of controlled atmosphere treatment. Such a mask may be dispensed as part of a component conveyance system or may be part of a component alignment portion. Either during component conveyance or alignment an actuated or otherwise automated assembly may place or drop or otherwise affix either a re-usable or disposable mask into those portions of a component surface not meant for plasma treatment and/or controlled atmosphere treatment. Depending on the type of treatment performed, the mask may have specific material properties such as thermal insulation, chemical resistance, and/or ground-plane properties. In further variations, the mask may be removed from the component at the completion of plasma treatment or as part of a conveyance process between a plasma treatment and/or controlled atmosphere treatment area and a material deposition area. In some variations, the same actuated or otherwise automated assembly that deposited the mask may remove it. In other variations, the mask may be lifted or peeled away from the component by compressed gas jet(s), suction devices, or actuated hooks/flanges.

In yet further variations, components may be selectively masked prior to material deposition. In some variations, a plasma-treated component may retain a mask applied prior to plasma processing such that neither plasma treatment nor material deposition is performed on the masked area. Such variations may be suitable for sputtering, screen printing, or vapor deposition systems. In other variations, a plasma treated component may be selectively masked for multiple material deposition sequences.

In a multiple deposition variation, a plasma-treated component may receive a first mask prior to a first material deposition process. The mask may then be removed and replaced with a complementary or partially complementary mask covering the deposited areas and exposing the treated, un-deposited areas for one or more subsequent deposition processes. Variations of such a multiple deposition process may include partially covering a component with an elastomeric material and partially covering the component in a hard coating such as urethane.

Referring again to FIG. 3a, variations of an atmosphere control portion 351 may include load locks such as air locks to facilitate component loading or transfer between plasma and non-plasma atmospheres, gas and vacuum pumps to add or remove air, buffer gases, or particular plasma or deposition gases or mixtures thereof to a processing chamber or processing area. Further variations may include filtration systems, pressure and temperature monitoring, gas/atmosphere composition monitoring, gas leak detection, automated chamber sealing/unsealing, and safety valves.

Variations of a component input/output portion 331 may include air lock/load lock chambers that allow for continuous processing in a controlled atmosphere without pauses or shutdowns for component loading or removal. Further variations may include cassette or tray-based component carriers. Further variations may also include conveyor systems or robotic/actuated portions that move components or component-bearing trays or cassettes into, through, and/or out of portions of the system. Yet further variations may include combinations of air locks, conveyors, actuators, and/or tray or cassette portions. Specific component loading and un-loading portions may be configured based on the particular components being processed, the particular combination of plasma and deposition process types, and the properties of the materials involved.

Variations of an operation/configuration interface 361 may include mechanical, electronic, electro-mechanical, computer-controlled, or fully computer-based user/operator interfaces that enable adjustment and control of processing parameters such as processing time in each stage, type of material deposited, deposition pattern and/or thickness, masking control or compensation, temperature, gas pressure, gas composition, conveyor speed, loading/unloading frequency, gas pump/vacuum sequence, plasma activation, component transfer, threshold/critical point configuration and detection for processing parameters, and malfunction monitoring.

Variations of data input/output 371 may include optical or magnetic disk drives, wireless data signal transmission, wired data signal transmission, user interfaces for manual data input, and connections to upstream, downstream, database or control systems that send and receive data. Variations of data processing 281 may include analog or digital data processing components such as signal processing circuits, FPGAs, ASICs, digital signal processors, or self-contained computing devices. Variations of data storage 391 may include a wide range of physical storage media including optical, magnetic, paper-based, volatile, non-volatile, removable, integrated, remote and/or database storage solutions.

In a preferred variation, a system as depicted in FIG. 3a may include a combination of flame plasma treatment and direct-write material deposition. Variations of direct-write material deposition in such a system may include ink jet deposition, laser direct-write, and micropen deposition.

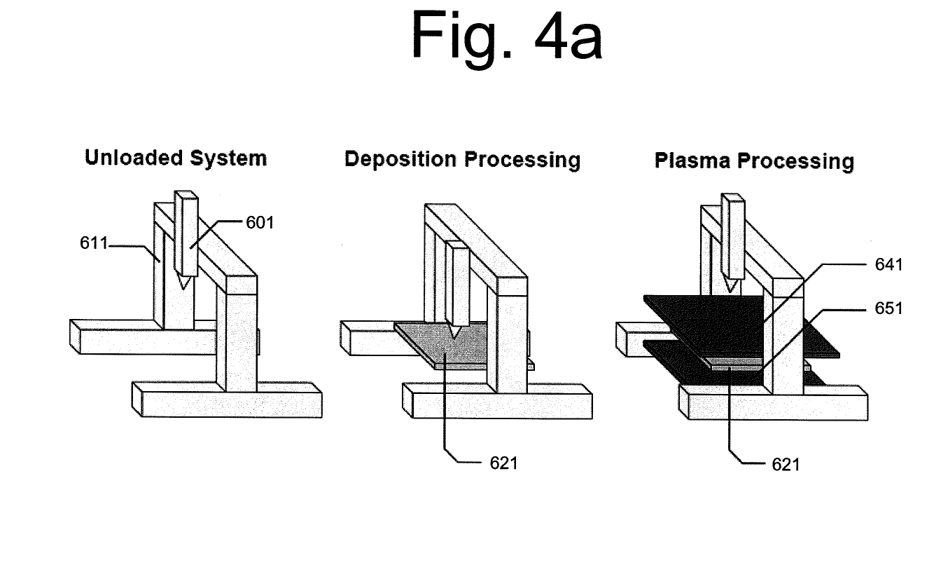

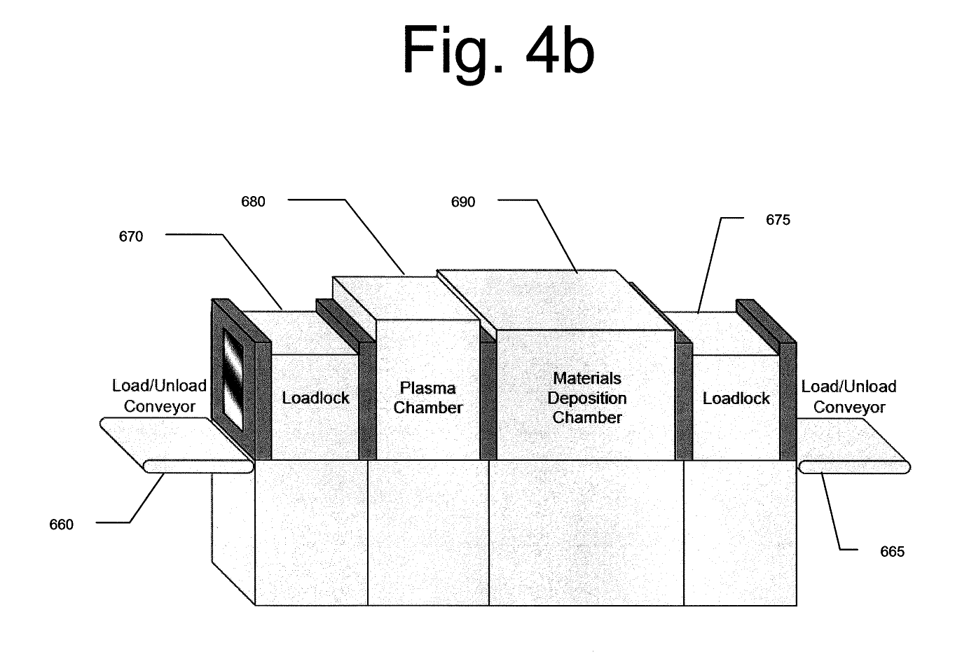

A variation of a single-chamber deposition and plasma treatment and/or controlled atmosphere treatment system is depicted in FIG. 4a. In the variation shown, a gantry 611 may be disposed inside a sealable chamber (not shown) with a direct-write deposition head 601 arranged thereon. A substrate 621 may be conveyed or otherwise positioned within or underneath the gantry to allow the deposition head 601 to deposit material(s) onto the substrate 621. Retractable plasma electrodes 641, 651 may be actuated such that they surround the substrate 621 for plasma processing either before or after a material deposition cycle. In some variations, a stage or platform that supports, aligns, or otherwise holds the substrate in position during deposition can also act as a bottom electrode. In further variations, one or both electrodes may be cooled by a cooling system (not shown). Cooling systems may also be used in some variations to allow for increased temperature during processing, thereby reducing cure time, followed by a cooling step/operation to allow earlier removal and/or safer handling.

Variations of a single-chamber deposition and treatment system may include vacuum pumps or other atmosphere/pressure control systems (not shown) for plasma activation as well as gas/atmosphere mixture and/or composition control for at least one of plasma treatment or deposition. Such variations may be suitable, in a sealed or sealable chamber, for depositing materials that are not stable in air or other oxygen-bearing environments or that may otherwise require inert atmospheres (nitrogen, argon, helium, etc.) to prevent undesired effects (oxidation, reaction with other chemicals, formation of unwanted compounds, evaporation or out-gassing) before processing can be completed. Further variations may include HEPA or Ultra Low Particulate Air (ULPA) filters to further reduce potential for contamination during pump-down or pressurization within the chamber.

Advantages of a single-chamber variation may include an overall reduction in complexity of the system and control over the gas environment of the workstation. Aspects of control may include the creation and implementation of gas combinations that could enhance deposition curing or allow new forms of curing. Other aspects of control may include pressure control such as operating at reduced pressures. A low-pressure environment may allow entrapped air to degas or outgas from a material. In a highly controlled atmosphere, such an outgassing may be followed by a pressure clamping process to reduce the size of any remaining voids. Furthermore, transitioning directly to plasma treatment or high-temperature curing immediately after a pressure clamping operation prevents the deposited material from undergoing any further physical or chemical changes due to air exposure between processing steps. Yet further aspects of a controlled environment include the ability to closely control contaminant and particulate levels. Single-chamber contaminant control allows for improved results during both plasma treatment and deposition with a single filtration/control system, thereby reducing both cost and complexity while improving production yields.

Further variations of a single-chamber system may include multiple or interchangeable deposition systems. One variation may have multiple direct-write pens or may have a direct-write deposition head, a spray deposition head, and a painting deposition head. Other variations may have interchangeable deposition heads or may have fully interchangeable or customizable deposition systems that can be varied between direct-write, sputtering, vapor deposition, screen printing, spray, dipping, and painting configurations. Yet further variations may include multiple, interchangeable, or otherwise configurable plasma systems. One variation may include an actuated corona treatment system in addition or instead of retractable electrodes or electrode plates. Other variations may include plasma treatment and/or controlled atmosphere treatment arrangements that can be configured or otherwise altered between chemical plasma, flame plasma, glow plasma, atmospheric plasma, corona treatment, and other plasma treatment techniques depending on the desired duration and intended effect of the plasma treatment on a component.

Yet further variations may include mask application/removal devices such as actuated/servo controlled arms or heads attached to a gantry or disposed in the processing chamber as retractable or semi-retractable components. In some variations, the plasma processing and/or controlled atmosphere treatment portion of the device may include a mask application and removal portion. A variation may include mask application during electrode plate extension. Another variation may include mask deposition as a precursor to a deposition process, such that a masking material is deposited, or a mask is otherwise placed onto the substrate, prior to a spraying, printing, vapor deposition, sputtering, or other deposition operation. Another variation still may include the application of a mask prior to any processing, such that a mask is deposited or applied before any plasma or deposition processing and removed after all processing steps requiring the mask are completed. Yet another variation may include deposition of a mask that is consumed during plasma treatment to prevent the underlying substrate portions from being affected by the plasma operation. Yet other variations may include the application and removal of component masks as separate operations performed respectively before and after the combined plasma and deposition processing.

Other variations of a combined plasma treatment and material deposition system may include a two-chamber treatment system. A variation of a two-chamber deposition and plasma treatment system is depicted in FIG. 4b. In the variation shown, loading/unloading conveyors 660, 665 convey components into, through, and out of a treatment system that includes a plasma chamber 680 and a deposition chamber 690 which are both isolated from the outside atmosphere with loadlocks 670, 675. The conveyors 660, 665, as well as an internal conveyance system (not shown) can be configured to alternate between forward and backward directions to allow for alternating cycles of plasma treatment and material deposition. Additional air-locks or other atmosphere separation/control mechanisms may be employed between the plasma chamber 680 and the material deposition chamber 690. Such air locks and/or atmosphere isolation devices may be useful to ensure that volatile gases used in plasma treatments and/or controlled atmosphere treatments in the plasma chamber 680 do not contaminate or otherwise interfere with the material deposition processes of the materials deposition chamber 690.

In some variations, for instance, a direct-write material deposition process may be preferably carried out in a vacuum, or in a nitrogen, argon, or helium atmosphere to minimize potential for surface contamination by reactive agents during deposition. The plasma chamber 680, by contrast, may be configured to expose a component to reactive gases and/or agents for surface modification prior to materials deposition. Such variations therefore preferably keep the atmospheres of the plasma chamber 680 and materials deposition chamber 690 isolated from each-other as well as from the outside atmosphere.

Advantages of such an arrangement include the ability to use modular, interchangeable plasma treatment and/or controlled atmosphere treatment and material deposition arrangements within an overall processing system framework. Such an arrangement may allow itself to be quickly re-configured from an atmospheric plasma treatment/controlled atmosphere treatment/direct-write system to a corona treatment/screen-printing system within minimal alterations to the overall system control and conveyance structures. Common, separate, or separately configurable atmospheric controls for the plasma 680 and deposition 690 chambers may be employed in variations of such a two-chamber system while still using a common overall control system and interface.

Variations of a two-chamber system may include one or more vacuum pumps or other atmosphere/pressure control systems and/or gas/atmosphere mixture and/or composition control for either or both plasma treatment 680 and deposition 690 chambers. Such variations may be suitable for treating and/or depositing materials that are not stable in air or other oxygen-bearing environments or that may otherwise require inert atmospheres (nitrogen, argon, helium, etc.) to prevent undesired effects (oxidation, reaction with other chemicals, formation of unwanted compounds, evaporation or out-gassing) before processing can be completed. Further variations may include HEPA or Ultra Low Particulate Air (ULPA) filters to further reduce potential for contamination during pump-down or pressurization within one or both chambers. Further variations still may include one or more cooling systems for either or both chambers as well as atmospheric controls for out-gassing and pressure clamping.

Yet further variations of a material deposition and plasma treatment and/or controlled atmosphere treatment system may include systems having more than two chambers, such as a system having an additional material deposition chamber or an additional plasma chamber and/or controlled atmosphere treatment chamber (or both). Such systems may also be configured for modular operation and may be configured such that chambers may be added or removed depending on the particular process desired. In such variations, a conveyance system may be expanded or contracted as modules are added or removed, or each module may have a built-in conveyance system that connects/interfaces with the conveyance systems of other modules. In some variations, loadlocks or pressure locks may be positioned between individual modules as well as on the loading/unloading ends of the system. In other variations, modules may be configured to share atmospheres and atmospheric controls such that overall gas environment composition, temperature, and pressure through two or more modules can be centrally regulated/controlled.

Variations of a two-chamber or multi-chamber system may also include mask application/removal aspects. Such masking components may be integrated into a processing chamber in a manner similar to that discussed in the single-chamber variation, or may be located in the loadlocks or otherwise integrated into the overall system as separate components depending on the type and duration of masking required.

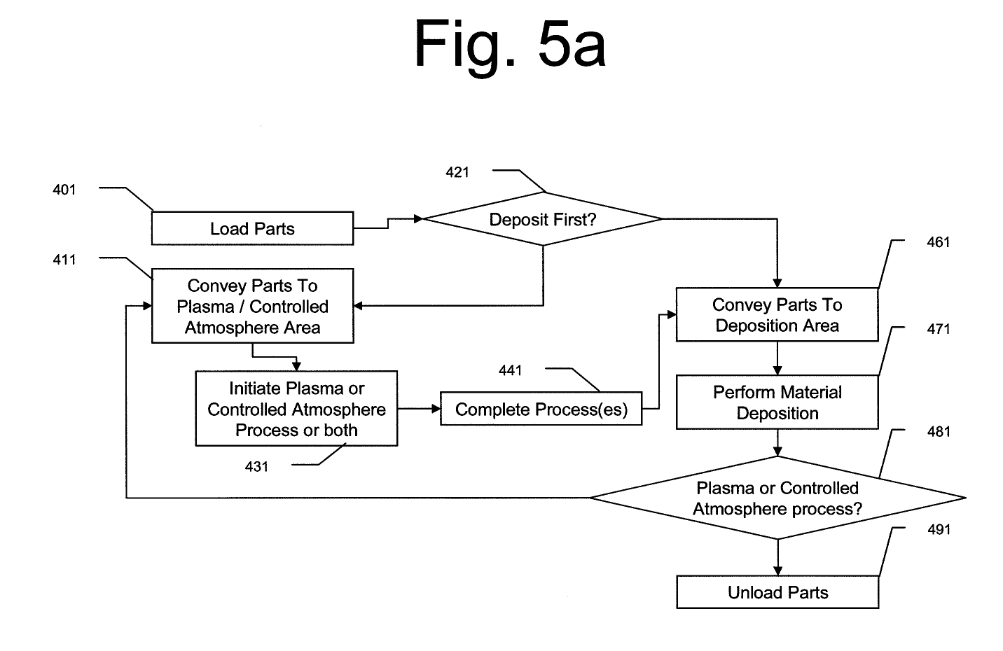

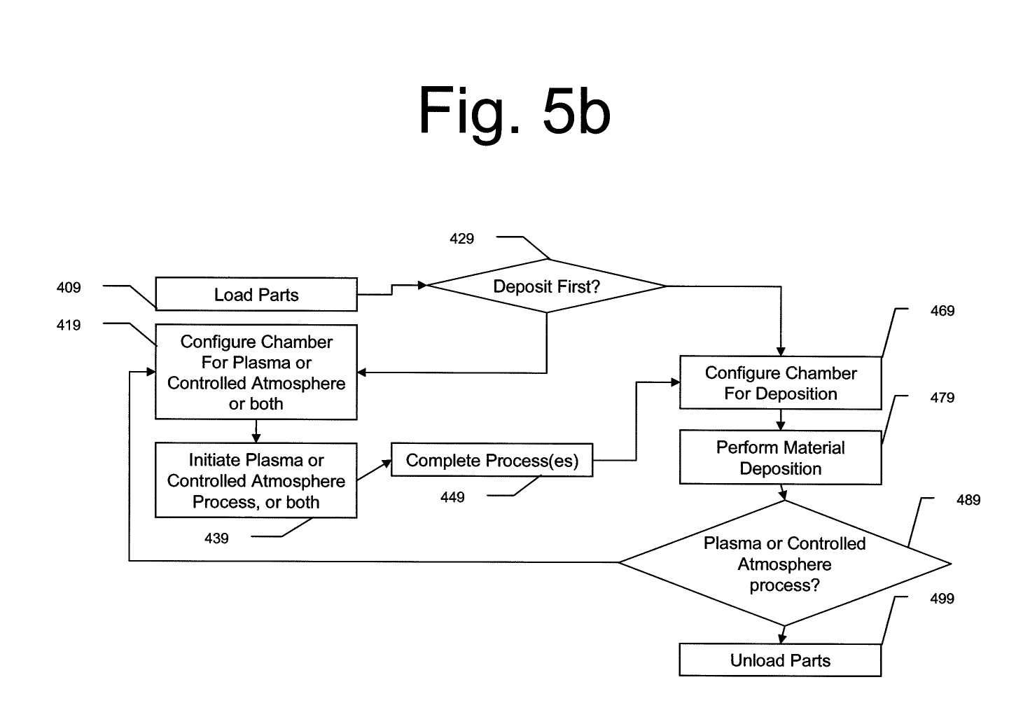

FIG. 5a shows an embodiment of a combined plasma treatment and/or controlled atmosphere treatment and materials deposition process using a system that has separate plasma treatment and/or controlled atmosphere treatment and material deposition areas. Variations of such a process include part loading 401, determination of whether to begin with plasma and/or controlled atmosphere or deposition 421, part conveyance to plasma and/or controlled atmosphere area 411 or deposition area 461, plasma and/or controlled atmosphere treatment process initiation 431 and completion 441, material deposition 471, a determination of whether further plasma and/or controlled atmosphere treatment processing is required 481, and part unloading 491 when processing is completed.

Variations of the load parts step 401 may include feeding parts into an automated loading system, engaging a conveyor, arranging parts in a tray or cassette, configuring and operating one or more air locks, or otherwise preparing and placing components or component-bearing trays or cassettes into a variation of a plasma and/or controlled atmosphere treatment and deposition system for processing.

Variations of a sequence determination step 421 may include a pre-programmed, operator selected, or otherwise configured set of instructions that determine whether a loaded component undergoes plasma treatment and/or controlled atmosphere treatment or material deposition first. Variations where material deposition is performed first convey the loaded component(s) to the deposition area 461 and variations where plasma treatment and/or controlled atmosphere treatment is performed first convey the loaded components to the plasma area 411.

Conveyance to the plasma and/or controlled atmosphere area 411 may include use of fully or partially automated conveyor systems, air locks, component-bearing trays or boats, and configurable conveyance speeds, atmosphere composition and temperature gradients, and heating/cooling profiles. In one variation, parts loaded into boats on a conveyor belt may be moved into an air lock or similar confined space having a sealed or sealable atmosphere. The air lock may then be gradually heated and flushed with gas to match the conditions in a plasma and/or controlled atmosphere chamber before being opened to permit further conveyance of the parts into a plasma and/or controlled atmosphere treatment chamber. In another variation, parts may be conveyed through a chamber or area maintained at vacuum before entering a plasma chamber. In yet further variations, parts may be conveyed directly into a plasma and/or controlled atmosphere treatment chamber which is then evacuated and subsequently filled with the appropriate gas mixtures and pressures.

Variations of initiation of the plasma and/or controlled atmosphere treatment process 431 may include taking advantage of known breaks or pauses in the deposition process, such as between material application steps. This is of particular importance given that the different materials will require different surface modifications to generate the desired product qualities.

Variations of completing the plasma and/or controlled atmosphere treatment process 441 may include simple timers, an etch-rate sensor, or more elaborate methods using optical or other techniques to detect chemical changes in the surface of that which is being treated.

After a variation of a plasma process has been completed, components may be conveyed to a parts deposition area 461. Variations of such a parts conveyance process may include use of fully or partially automated conveyor systems, air locks, component-bearing trays or boats, and configurable conveyance speeds, atmosphere composition and temperature gradients, and heating/cooling profiles. In one variation, parts loaded into boats on a conveyor belt may be moved into an air lock or similar confined space having a sealed or sealable atmosphere. The air lock may then be gradually cooled and/or flushed with gas to match the conditions in the deposition area. In other variations parts maybe conveyed through a chamber or area maintained at a vacuum or flushed with helium or nitrogen or argon.

In other variations, a plasma process may be supplemented and/or replaced with an atmosphere treatment process. Such atmosphere treatment may include exposure pure oxygen, carbon monoxide, halogen gases and/or unstable gases such as ozone, nitrous oxide, and/or halogenated noble gas compounds.

Variations of a material deposition process 471 may include direct-write deposition, sputtering, spraying, or vapor deposition. In some variations the deposition process may be performed in an oxygen-free environment, such as a nitrogen or argon atmosphere, in order to prevent degradation of the plasma-treated surface before deposition it completed. In other variations, deposition may be performed under oxygen-bearing atmosphere conditions but with minimal delay or exposure time between plasma treatment and deposition. In vapor deposition variations, the deposition process may be performed in atmospheric conditions similar to that used for plasma treatment.

After completing material deposition, variations of a determination step for further plasma and/or controlled atmosphere treatment processing 481 may include may include a pre-programmed, operator selected, or otherwise configured set of instructions that determine whether a loaded component undergoes further plasma treatment based on the processing steps taken so far. Variations where no further plasma and/or controlled atmosphere treatment processing is called for may convey the component(s) to an unloading area 491 or otherwise eject or unload the parts from the processing area(s). Variations where further plasma processing is called for may convey the components to the plasma area 411.

One variation of a multiple-iteration treatment and deposition process may include applying a mask to a component during conveyance to the plasma and/or controlled atmosphere treatment area 411, treating and performing material deposition on the masked component, then removing the first mask and applying a subsequent complementary or partially complementary mask during a subsequent conveyance operation 411 for a subsequent treatment and material deposition operation. An example of such a variation may include a component requiring an easily strippable coating in some parts and a strongly adhering coating in others. A first plasma processing iteration could reduce surface adhesion prior to deposition of the strippable coating and a second plasma processing iteration could increase surface adhesion prior to deposition of the strongly adhering coating. A component that is to be coated partially with silicone and partially with urethane may be a candidate for such a processing variation. In such a variation, the conveyance process may include automated application and removal of appropriate masks to the component surface through actuators, dispensers, or other suitable devices.

FIG. 5b shows an embodiment of a combined plasma treatment and/or controlled atmosphere treatment and materials deposition process using a system that has a single chamber or processing area used for both plasma treatment and/or controlled atmosphere treatment and material deposition. Variations of such a process include part loading 409, determination of whether to begin with plasma treatment or material deposition 429, configuration of the chamber or processing area for either plasma processing 419 or material deposition 469, plasma process initiation 439 and completion 449, material deposition 479, a determination of whether further plasma processing and/or controlled atmosphere treatment is required after material deposition 489, and part unloading 499 when processing is completed.

Variations of the load parts step 409 may include feeding parts into an automated loading system, engaging a conveyor, arranging parts in a tray or cassette, configuring and operating one or more air locks, or otherwise preparing and placing components or component-bearing trays or cassettes into a variation of a plasma and/or controlled atmosphere treatment and deposition system for processing.

Variations of a sequence determination step 429 may include a pre-programmed, operator selected, or otherwise configured set of instructions that determine whether a loaded component undergoes plasma treatment and/or controlled atmosphere treatment or material deposition first. Variations where plasma processing and/or controlled atmosphere treatment is performed first configure or prepare the chamber or processing area for plasma processing 419 and variations where material deposition is performed first configure or prepare the chamber or processing area for material deposition 469.

Variations of a plasma and/or controlled atmosphere treatment configuration process 419 may include sealing or otherwise atmospherically isolating the chamber or processing area, or a portion thereof. In some variations, configuration for plasma 419 may include retracting or otherwise removing material deposition equipment from the chamber. In yet further variations, it may include introducing or engaging plasma processing equipment (such as electrodes and reaction gas nozzles) into the chamber. In further variations still, it may include creating a sealed chamber around an otherwise atmospherically un-sealed work area and/or adjusting gas and temperature composition within the plasma and/or controlled atmosphere treatment chamber to a point where a plasma and/or controlled atmosphere treatment process can be initiated.

In some variations, such as systems using a direct-write deposition system, a deposition configuration may be the default setting or default state of the chamber or processing area. In other variations, a plasma processing and/or controlled atmosphere treatment configuration may be the default setting. In yet further variations, the initial configuration setting of the chamber may be configured based on an operating program or an operator command.

Variations of initiation of the plasma and/or controlled atmosphere treatment process 439 may include taking advantage of known breaks or pauses in the deposition process, such as between material application steps. This is of particular importance given that the different materials will require different surface modifications to generate the desired product qualities.

Variations of completing the plasma and/or controlled atmosphere treatment process 449 may include simple timers, an etch-rate sensor, or more elaborate methods using optical or other techniques to detect chemical changes in the surface of that which is being treated.

Variations of a deposition configuration process 469 may include un-sealing or otherwise atmospherically venting the chamber or processing area, or a portion thereof. In some variations, configuration for deposition 469 may include retracting or otherwise removing plasma equipment from the chamber. In yet further variations, it may include introducing or engaging deposition processing equipment (such as actuated or moveable direct-write devices) into the chamber. In further variations still, it may include opening a sealed chamber into an atmospherically un-sealed work area and/or adjusting gas and temperature composition within the deposition chamber to a point where a deposition process can be performed.

Variations of a material deposition process 479 may include direct-write deposition, sputtering, or vapor deposition. In some variations the deposition process may be performed in an oxygen-free environment, such as a nitrogen or helium atmosphere, in order to prevent degradation of the plasma-treated and/or controlled atmosphere treated surface before deposition it completed. In other variations, deposition may be performed under normal atmosphere conditions but with minimal delay or exposure time between plasma treatment and deposition. In vapor deposition variations, the deposition process may be performed in atmospheric conditions similar to that used for plasma and/or controlled atmosphere treatment.

After completing material deposition, variations of a determination step for further plasma processing 489 may include may include a pre-programmed, operator selected, or otherwise configured set of instructions that determine whether a component undergoes further plasma treatment based on the processing steps taken so far. Variations where no further plasma processing is called for may convey the component(s) to an unloading area 499 or otherwise eject or unload the parts from the processing area(s). Variations where further plasma processing is called for may re-configure the chamber or work area for plasma processing 419.

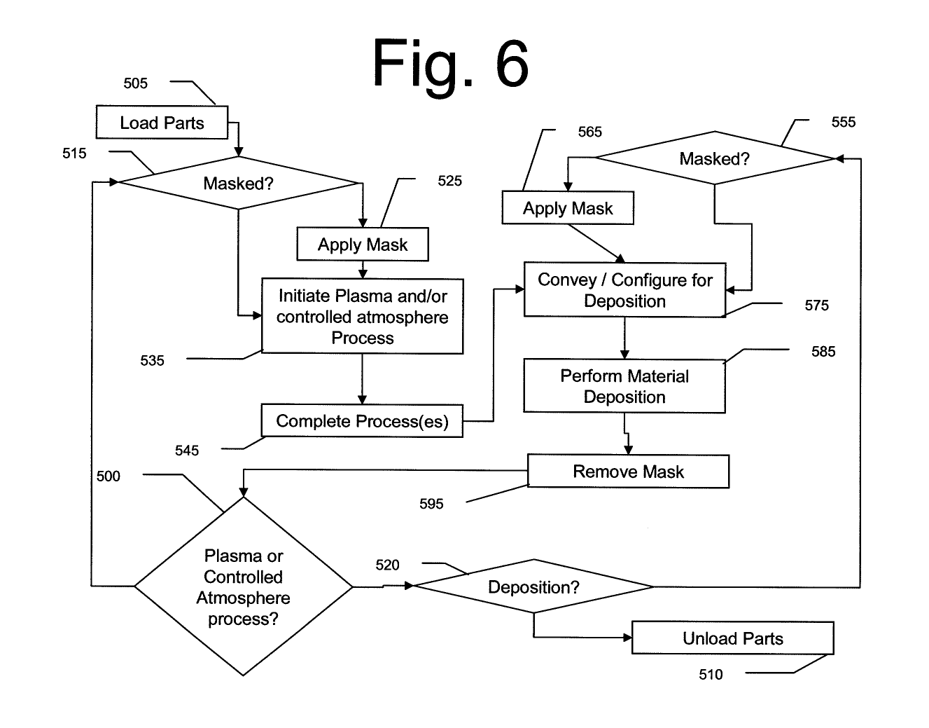

FIG. 6 shows an embodiment of a combined plasma and/or controlled atmosphere treatment processing and material deposition process with masking capability. In the variation shown, after parts are loaded 505 into a variation of a combined plasma and/or controlled atmosphere treatment processing/materials deposition system, a determination is made whether or not to apply a mask to the component prior to plasma and/or controlled atmosphere treatment activation 515. Based on this determination, a mask may be applied 525 prior to initiating the plasma and/or controlled atmosphere process 535. After the plasma/atmosphere process completes 545, the component(s) may be conveyed (in a multi-chamber system) or oriented (in a single chamber system) 575 for material deposition. In the variation shown, the conveyance/configuration step 575 does not affect any mask applied for plasma processing. In alternate variations, the conveyance/orientation 575 may include mask removal and/or mask application prior to material deposition.

In some variations, the orientation step 575 may include a re-configuration of the processing chamber. Such variations may include un-sealing or otherwise atmospherically venting the chamber or processing area, or a portion thereof. In some variations, configuration for deposition 575 may include retracting or otherwise removing plasma equipment from the chamber. In yet further variations, it may include introducing or engaging deposition processing equipment (such as actuated or moveable direct-write devices) into the chamber. In further variations still, it may include opening a sealed chamber into an atmospherically un-sealed work area and/or adjusting gas and temperature composition within the deposition chamber to a point where a deposition process can be performed.

After conveyance/orientation/configuration 575, a material deposition operation 585 may be performed. Variations of a material deposition process 585 may include direct-write deposition, sputtering, or vapor deposition. In some variations the deposition process may be performed in an oxygen-free environment, such as a nitrogen or helium atmosphere, in order to prevent degradation of the plasma-treated and/or controlled atmosphere treated surface before deposition it completed. In other variations, deposition may be performed under normal atmosphere conditions but with minimal delay or exposure time between plasma treatment and deposition. In vapor deposition variations, the deposition process may be performed in atmospheric conditions similar to that used for plasma and/or controlled atmosphere treatment.

Once the material deposition is performed 585, any mask on the component for the deposition process may be removed 595. In variations that do not use masking, the mask application 525 and mast removal 595 operations may be omitted. A logic operation may then ensue to determine if further plasma and/or controlled atmosphere treatment 500 is required at that stage of the processing/production sequence. If further plasma and/or controlled atmosphere treatment processing is required, a determination may be made whether that further processing requires a mask 515. In variations that do not use masks and/or masking techniques or variations that always use masks/masking techniques, such a determination 515 may be omitted.

If further plasma processing is not required, a determination is made as to whether another material deposition cycle is required 520 at this stage of the processing/production sequence. If no further deposition is required, then processing has completed and the parts may be unloaded 510.

If further material deposition processing is required, a determination is made as to whether it is masked or un-masked deposition processing 555. In the event a mask is required, a mask is applied 565 prior to getting the component and system ready for another material deposition sequence 575. In variations that do not use masks and/or masking techniques or variations that always use masks/masking techniques, such a determination 555 may be omitted.

After material deposition completes 585, the mask may be removed 595 (if applicable) and the logic sequence to determine further processing 500, 520 may be repeated.

In other variations, the process may be initiated with a material deposition step that may be masked or un-masked. In yet further variations, any or all mask application or mask determination steps may be omitted such that a process is configured to operate either always using masks in a specific sequence, or without any masking at all.

Variations employing direct-write material deposition solutions may be configured for masked or un-masked plasma and/or controlled atmosphere treatment activation and un-masked material deposition as the direct-write system may be configured to simply not write onto those component portions where material deposition is not desired. Variations employing sputtering or vapor deposition techniques may involve masked material deposition operations regardless of whether plasma activation is masked or not. Variations employing multiple material deposition sequences on a single plasma-activated surface may apply complementary masks for the different material deposition sequences such that each un-masked portion gets a particular material or material combination deposited thereon. Similarly with controlled atmosphere treatment processes.

Variations of a system according to the present invention may be used for conformal coatings, board lamination adhesion promotion, EMI shield applications, and other material deposition applications where effective and timely plasma and/or controlled atmosphere treatment processing may enhance or otherwise impart desire properties to material surfaces or interfaces.

The invention being thus described, it will be obvious that the same may be varied in many ways. Such variations are not to be regarded as departure from the spirit and scope of the invention, and all such modifications as would be obvious to one skilled in the art are intended to be included within the scope of the following claims.

1. A combined controlled atmosphere treatment and material deposition apparatus, the apparatus comprising:
a material deposition chamber housing a material deposition portion that deposits material onto a component;
a controlled atmosphere treatment chamber housing a controlled atmosphere treatment portion that modifies a surface of the component by controlled atmosphere treatment;
an atmosphere control portion that regulates an internal atmosphere composition, temperature, and pressure based on whether the apparatus is performing material deposition, plasma treatment, or controlled atmosphere treatment;
a component transport portion that moves components between the controlled atmosphere treatment portion and the material deposition portion; and
a component alignment portion that controls component positioning and alignment for at least one of plasma and/or controlled atmosphere treatment and material deposition portions.

2. The apparatus of claim 1, where the material deposition portion includes at least one of a screen printing and a direct-write deposition system.

3. The apparatus of claim 2, where the material deposition system is a micropen system.

4. The apparatus of claim 1, the apparatus further comprising a controlled atmosphere treatment masking portion that applies and removes a mask to the component such that only the un-masked portions of the component are controlled atmosphere treated.

5. The apparatus of claim 1, the apparatus further comprising a deposition masking portion that applies and removes a mask to the component such that only the un-masked portions of the component undergo material deposition.

6. The apparatus of claim 1, the apparatus further including:
a data storage portion that stores an operating profile or operating parameters for both controlled atmosphere treatment and material deposition portions; and
a process control portion that monitors and controls atmosphere composition, pressure, and temperature in the deposition and treatment chambers, treatment and deposition durations, component transport speed and timing and the controlled atmosphere treatment and material deposition portions based on the operating profile or operating parameters.

7. The apparatus of claim 1, the process control portion including a cycle repetition control portion that controls the apparatus to perform multiple iterations of an operating sequence that includes alternating sequences of controlled atmosphere treatment and material deposition.

8. The apparatus of claim 7, where the cycle repetition control portion also controls the apparatus to perform multiple iterations of material deposition without intervening controlled atmosphere treatment.

9. The apparatus of claim 1, the apparatus further including:
an intake loadlock that allows components to be loaded into the combined apparatus without affecting internal atmosphere conditions in the apparatus; and
an output loadlock that allows components to be removed from the combined apparatus without affecting internal atmosphere conditions in the apparatus;
where one of the loadlocks controls access to the material deposition chamber and the other one of the loadlocks control access to the controlled atmosphere treatment chamber.

10. The apparatus of claim 1, where the component alignment portion controls component positioning and alignment for both controlled atmosphere treatment and material deposition portions.

11. The apparatus of claim 2, where the apparatus configuration portion controls a configuration of the material deposition system such that at least part of the deposition system is in a retracted state when the apparatus is configured for controlled atmosphere treatment processing.

12. The apparatus of claim 9, the apparatus further including an inter-chamber air-lock that isolates the atmosphere of the controlled atmosphere treatment chamber from the atmosphere for the material deposition chamber and allows components to be moved between the chambers without affecting internal atmosphere conditions in either chamber.

13. The apparatus of claim 1, where the controlled atmosphere treatment portion is a plasma treatment portion.

14. A combined controlled atmosphere treatment and material deposition apparatus, the apparatus comprising:
a processing chamber;
a material deposition portion that deposits material onto a component, said material deposition portion being disposed in said chamber;
a controlled atmosphere treatment portion that modifies a surface of the component by controlled atmosphere treatment, said controlled atmosphere treatment portion being disposed in said chamber;
an atmosphere control portion that regulates an internal atmosphere composition, temperature, and pressure in the chamber based on whether the apparatus is performing material deposition or controlled atmosphere treatment;
an apparatus configuration portion that changes the configuration of the apparatus between a controlled atmosphere treatment processing configuration and a material deposition configuration; and
a component alignment portion that controls component positioning and alignment for at least one of controlled atmosphere treatment and material deposition.

15. The apparatus of claim 14, where the controlled atmosphere treatment portion includes at least one retractable electrode, the extension and retraction of said electrode being controlled by the apparatus configuration portion.

16. The apparatus of claim 14, where the material deposition portion includes at least one of a spraying and a direct-write deposition system.

17. The apparatus of claim 14, where the material deposition system is a micropen system.

18. The apparatus of claim 14, where the processing chamber is selectively sealable such that it can be in an atmospherically sealed state and an atmospherically un-sealed state, and where the apparatus configuration portion controls atmospheric sealing and un-sealing of the chamber.

19. The apparatus of claim 14, the apparatus further including:
a data storage portion that stores an operating profile or operating parameters for both plasma and/or controlled atmosphere treatment and material deposition;
an atmosphere control portion that monitors and controls atmosphere composition, pressure, and temperature in the chamber based on the operating profile or operating parameters; and
a data processing portion that controls plasma and/or controlled atmosphere treatment and material deposition in the apparatus based on the operating profile or operating parameters.

20. The apparatus of claim 14, where the component alignment portion control component positioning and alignment for both controlled atmosphere treatment and material deposition.

21. The apparatus of claim 14, where the controlled atmosphere treatment portion is a plasma treatment portion.

22. A method of performing controlled atmosphere treatment and material deposition using a single processing device, the method comprising:
loading a component into the device for processing;
controlled atmosphere treating of a surface of the component in a controlled atmosphere treatment section of the device;
conveying the controlled atmosphere treated component to a material deposition section of the device; and
performing material deposition on the plasma and/or controlled atmosphere treated surface;
where said conveying is performed by the device.

23. The method of claim 22, where said conveying is performed such that the controlled atmosphere treated component is not exposed to air between the controlled atmosphere treatment and material deposition steps.

24. The method of claim 22, where said material deposition is direct-write deposition.

25. The method of claim 22, where said controlled atmosphere treatment is flame plasma treatment.

26. The method of claim 22, the method further comprising determining, after said material deposition step, whether further controlled atmosphere treatment processing is required;
conveying the component to the controlled atmosphere treatment section when further controlled atmosphere treatment processing is required;
performing further controlled atmosphere treatment on a surface of the component;
conveying the further controlled atmosphere treated component back to the material deposition portion; and
performing subsequent material deposition on the further controlled atmosphere treated surface.

27. The method of claim 22, where the controlled atmosphere treating include treating the component surface to reduce surface adhesion and the material deposition step includes depositing a silicone elastomer onto the controlled atmosphere treated surface.

28. The method of claim 22, where said controlled atmosphere treating includes exposing the component to a halogenated noble gas.

29. A method of performing controlled atmosphere treatment and material deposition using a single processing device, the method comprising:
loading a component into the processing chamber of said device for processing;
configuring the chamber for controlled atmosphere treatment;
controlled atmosphere treating a surface of the component in the controlled atmosphere treatment configuration;
configuring the chamber for material deposition; and
performing material deposition on the controlled atmosphere treated surface in the material deposition configuration;
where said configuring is performed by the device based on an operating profile or user-defined settings.

30. The method of claim 29, the method further comprising determining, after said material deposition step, whether further controlled atmosphere treatment processing is required;
configuring the chamber for further controlled atmosphere treatment;
further controlled atmosphere treating a surface of the component in the plasma treatment configuration;
configuring the chamber for further material deposition; and
performing further material deposition on the controlled atmosphere treated surface in the material deposition configuration.

31. The method of claim 29, where performing material deposition includes performing direct-write deposition.

32. The method of claim 29, where configuring the chamber for controlled atmosphere treatment includes moving retractable electrode plates such that at least one electrode plate is above the component and one electrode plate is below the component to allow for a plasma to be created between them.

33. The method of claim 29, said configuring the chamber for material deposition including at least one of venting the controlled atmosphere treatment atmosphere from the chamber and flushing the chamber with argon gas before said performing material deposition.

34. The method of claim 29, where said controlled atmosphere treating includes plasma treating the surface of the component.
